(19) United States
(12) Patent Application Publication
(10) Pub. No.: US 2026/0353447 A1
(43) Pub. Date: Nov. 5, 2026

(54) METHOD OF COORDINATING COMMUNICATION OF TWO COMMUNICATION SYSTEMS THAT ARE NOT INTEROPERABLE AND USE AN AT LEAST PARTLY SHARED RESOURCE

(71) Applicants: Continental Automotive Technologies GmbH, Hannover (DE); NANYANG TECHNOLOGICAL UNIVERSITY, Singapore (SG)

(72) Inventors: David GONZÁLEZ GONZÁLEZ, Frankfurt am Main (DE); Rakshith JAGANNATH, Singapore (SG); Yong Liang GUAN, Singapur (SG)

(73) Assignees: Continental Automotive Technologies GmbH, Hannover (DE); NANYANG TECHNOLOGICAL UNIVERSITY, Singapore (SG)

(21) Appl. No.: 19/099,882

(22) PCT Filed: Aug. 4, 2023
(86) PCT No.: PCT/IB2023/057907

§ 371 Date: Jan. 30, 2025

(30) Foreign Application Priority Data
Aug. 5, 2022 (SG) 10202250680W

(51) Int. Cl. H04W 74/0816; H04W 28/26; H04W 72/044

(52) U.S. Cl. CPC H04W 74/0816; H04W 28/26; H04W 72/044

(57) ABSTRACT

A method of coordinating access of at least one first-type apparatus including a first-type wireless interface, at least one second-type apparatus including a second-type wireless interface, and at least one third type apparatus including both a first-type wireless interface and a second-type wireless interface that are communicatively coupled to each other, to a radio resource is presented, parts or portions of which radio resource within the time interval being at least partly and/or temporarily used shared between the first-type, second-type and third-type apparatus. The first-type and second-type wireless communication interfaces are not interoperable. The method proposes, in dual-mode UEs, distributing information about resource reservations for first-type wireless interfaces and second-type wireless interfaces to single-mode UEs using wireless interfaces of the respective other type.

### CROSS REFERENCE TO RELATED APPLICATIONS

This application is the U.S. National Phase Application of PCT International Application No. PCT/IB2023/057907, filed Aug. 4, 2023, which claims priority to Singapore Patent Application No. 10202250680W, filed Aug. 5, 2022, the contents of such applications being incorporated by reference herein.

### FIELD OF THE INVENTION

The present invention relates to wireless communication, more specifically to the coordination of the use of an at least partly shared resource pool.

### BACKGROUND OF THE INVENTION

In today's connected world many devices are connected to other devices or systems through wireless connections. Such devices may include portable or mobile devices, sensors, and even motor vehicles. Several communication standards have been developed, deployed, and retired, in the past, all of which use a respective portion of the wireless spectrum for transmitting. Some older wireless communication standards include GSM (global system for mobile communication), also referred to as 2G, and UMTS (universal mobile telecommunication system), also referred to as 3G. While not fully retired, their data rates and capability to simultaneously serve a large number of users do not live up to the requirements of the ever increasing number of connected mobile devices, which led to the development and deployment of LTE (long term evolution), or 4G, and later NR (new radio), also referred to as 5G.

One important use case for both LTE and NR communication systems is found in intelligent transportation systems (ITS), which increasingly implement vehicle-to-vehicle (V2V), vehicle-to-infrastructure (V2I) and other communication between vehicles and radio-enabled objects or services in relative proximity of the vehicle. The acronym V2X, for vehicle-to-everything (or anything, for that matter) is meant to cover all conceivable communication scenarios.

In V2X communication the data transfer is preferably done directly between the communication partners, without using a base station or other elements of the network as intermediary, since direct communication exhibits less delay between transmission and reception. As such direct communication may use the same communication interface as the LTE or NR communication that goes to and trough the corresponding network, but the data is not routed to the base station and through the network, the direct communication is also referred to as ‘sidelink’communication, or SL.

LTE V2X is expected to operate on the 5.9 GHz band reserved in certain markets, e.g., United States, Europe, China, for ITS services. For SL communications, vehicles, or user equipment (UE), as used interchangeably herein, utilize the so-called PC5 interface, whereas they utilize the Uu interface for vehicle-to-network (V2N) communication. LTE V2X has been designed to support basic cooperative active traffic safety, traffic management, and telematics applications and services. LTE V2X supports similar services as those supported by DSRC or its European counterpart ITS-G5. These applications and services rely on the broadcast transmission of small awareness messages such as cooperative awareness messages (CAM) in ITS-G5 or basic safety messages (BSM) in DSRC to regularly provide basic information such as the location, direction, speed, and acceleration of the transmitting vehicle. LTE V2X defines new physical (PHY) and medium access control (MAC) layers for V2X and reuses the upper V2X layers and protocols specified by ETSI (European Telecommunications Standardization Institute), IEEE (Institute of Electrical and Electronic Engineers), and SAE (Society of Automotive Engineers).

LTE V2X defines two resource allocation modes, mode 3 and mode 4, for V2X SL communications. In mode 3, the cellular infrastructure (eNB) manages the V2X SL communications. This includes selecting and configuring the communication resources, i.e., sub-channels. Mode 4 can operate without cellular infrastructure support. In this case, vehicles autonomously select, manage and configure the sub-channels. Vehicles utilizing mode 3 need to be in network coverage, while vehicles using mode 4 can operate out of network coverage.

LTE V2X uses SC-FDMA (Single-Carrier Frequency-Division Multiple Access) and supports 10 MHz and 20 MHz channels. The channel is divided into 180 kHz Resource Blocks (RBs) that correspond to 12 subcarriers of 15 kHz each. In the time domain, the channel is organized into 1 ms subframes. FIG. 1 illustrates the channelization in LTE V2X mode 4 sensing-based SPS scheduling with an exemplary length T=100 ms.

Each subframe has 14 OFDM symbols with normal cyclic prefix. Nine of these symbols are used to transmit data and four of them (3rd, 6th, 9th, and 12th) are used to transmit demodulation reference signals (DMRSs) for channel estimation and combating the Doppler effect at high speeds. The last symbol is used as a guard symbol for timing adjustments and for allowing vehicles to switch between transmission and reception across subframes.

RBs are grouped into sub-channels. A sub-channel can include RBs only within the same subframe. The number of RBs per sub-channel can vary and is (pre-)configured. (Pre-)configuration refers to a configuration that is:
1) defined by the network and signalled to the UE by the cellular base station (eNB or gNB) when a UE is in network coverage; or
2) predefined in the UE when the UE is out of network coverage. Sub-channels are used to transmit data and control information. The data is organized in Transport Blocks (TBs)

The LTE standard does not specify an algorithm for the selection of sub-channels in mode 3. Instead, it defines two scheduling approaches, dynamic scheduling and Semi-Persistent Scheduling (SPS). With dynamic scheduling, UEs must request sub-channels from the eNB for each TB. With SPS scheduling, the eNB reserves sub-channels so that a UE can transmit several TBs. The eNB can configure the periodicity of the reserved sub-channels. LTE mode 3 can outperform LTE mode 4 since the scheduling of transmissions is centralized at the eNB. However, it requires operating in network coverage and introduces cellular uplink (UL) and downlink (DL) signalling overhead. LTE mode 3 can also encounter challenges at the cell boundaries, in particular when different operators serve neighbouring UEs.

Under LTE mode 4, UEs autonomously select their sub-channels using the sensing-based SPS scheduling scheme specified in 3GPP Release 14/15. A UE uses the selected sub-channels for the transmission of its following Reselection Counter consecutive TBs. The UE announces the reservation of the selected sub-channels for the transmission of the next TB using the Resource Reservation Interval (RRI) included in the sidelink control information (SCI). This is also illustrated in FIG. 1, where a UE selects sub-channel(s) at subframe trx, and informs neighbouring UEs that it reserves them for its following transmission at subframe trx+RRI. This is done to prevent other UEs from utilizing the same sub-channels at the same time. The RRI can be equal to 0 ms, 20 ms, 50 ms, 100 ms or any multiple of 100 ms up to a maximum value of 1000 ms. A UE sets the RRI equal to 0 ms to announce neighbouring UEs that it is not reserving the same sub-channels for the next TB. A UE can only select RRIs values higher than 0 ms from a (pre-)configured list of permitted RRI values. This list can contain up to 16 values although currently 3GPP standards only define 12 possible RRIs values higher than 0 ms for mode 4.

5G NR V2X has been designed to complement LTE V2X. While LTE V2X supports basic active safety and traffic management use cases, 5G NR V2X supports advanced use cases and higher automation levels. Like LTE, the 5G system architecture supports two operation modes for V2X communication, namely V2X communication over the PC5 reference point or interface and V2X communication over the Uu reference point or interface.

5G NR is specified for operation in two frequency ranges, FR1 extending from 450 MHz to 6 GHz and FR2 extending from 24.25 GHz to 52.6 GHz. In NR Uu, the maximum carrier bandwidth is 200 MHz for FR1 and 400 MHz in FR2. Although the NR infrastructure (gNB) can support such wide bandwidths, this may not be the case for all UEs, in particular low-end UEs. Furthermore, supporting a very large bandwidth may also imply higher power consumption at the UE, both from the radio frequency (RF) and baseband signal processing perspectives. To support UEs that cannot handle large bandwidths, e.g., due to processing limitations or high power consumption, the concept of bandwidth part (BWP) has been introduced. A BWP consists of a contiguous portion of bandwidth within the carrier bandwidth where a single numerology is employed. By defining a small BWP, the computational complexity and power consumption of a UE can be reduced. As each BWP can have a different bandwidth and numerology, BWPs enable a more flexible and efficient use of the resources by dividing the carrier bandwidth for multiplexing transmissions with different configurations and requirements.

In 5G NR V2X, a subset of the available SL resources is (pre-)configured to be used by several UEs for their SL transmissions. This subset of available SL resources is referred to as a resource pool (RP) and is illustrated in FIG. 2. A resource pool comprises different sub channels and multiple time slots. The common resource blocks within an RP are referred to as physical resource blocks (PRB). An RP consists of contiguous PRBs and contiguous or non-contiguous slots that have been (pre-)configured for SL transmissions. An RP must be defined within the SL BWP. Therefore, a single numerology is used within an RP. If a UE has an active uplink (UL) BWP, the SL BWP must use the same numerology as the UL BWP if they are both included in the same carrier. Otherwise, the SL BWP is deactivated.

In the frequency domain, an RP is divided into a (pre-)configured number L of contiguous sub-channels, where a sub-channel consists of a group of consecutive PRBs in a slot. The number Msub of PRBs in a sub-channel corresponds to the sub-channel size, which is (pre-)configured within an RP. In NR V2X SL, the sub-channel size Msub can be equal to 10, 12, 15, 20, 25, 50, 75, or 100 PRBs. A sub-channel represents the smallest unit for a sidelink data transmission or reception. A sidelink transmission can use one or multiple sub-channels. In the time domain, the slots that are part of an RP are (pre-)configured and occur with a periodicity of 10240 ms. The slots that are part of an RP can be (pre-)configured with a bitmap. The length of the bitmap can be equal to 10, 11, 12, . . . , 160.

An RP can be used for all transmission types, i.e., unicast, groupcast, and broadcast, and can be shared by several UEs for their SL transmissions. A UE can be (pre-)configured with multiple RPs for transmission, i.e., transmit RPs, and with multiple RPs for reception, i.e., receive RPs. A UE can then receive data on resource pools used for SL transmissions by other UEs, while the UE can still transmit on the SL using its transmit resource pools. 5GAA release 16 defines two modes, mode 1 and mode 2, for the selection of sub-channels in NR V2X SL communications using the NR V2X PC5 interface. These two modes are the counterparts to modes 3 and 4 in LTE V2X discussed further above. However, LTE V2X only supports broadcast SL communications while NR V2X supports broadcast, groupcast, and unicast SL communications.

Similar to mode 3 in LTE V2X, in NR mode 1 the gNB assigns and manages the SL radio resources for V2V communications using the NR Uu interface. UEs must therefore be in network coverage to operate using NR mode 1. SL radio resources can be allocated from licensed carriers dedicated to SL communications or from licensed carriers that share resources between SL and UL communications. The SL radio resources can be configured so that NR mode 1 and NR mode 2 use separate resource pools. The alternative is that NR mode 1 and NR mode 2 share the resource pool. Pool sharing can result in a more efficient use of the resources, but it is prone to potential collisions between NR mode 1 and NR mode 2 transmissions. To solve this, NR mode 1 UEs notify NR mode 2 UEs of the resources allocated for their future transmissions.

NR mode 1 uses dynamic grant (DG) scheduling like LTE V2X mode 3, but replaces the semi-persistent scheduling in LTE V2X mode 3 with a configured grant scheduling. With DG, NR mode 1 UEs must request resources to the base station for the transmission of every single TB. To this end, the UEs must send a Scheduling Request (SR) to the gNB, and the gNB responds by indicating the SL resources, i.e., the slot(s) and sub-channel(s), allocated for the transmission of a TB and up to 2 possible retransmissions of this TB. The UE informs other UEs about the resources it will use to transmit a TB and up to 2 possible retransmissions using the 1st-stage SCI messages. Nearby UEs operating under NR mode 2 can then know which resources UEs in NR mode 1 will utilize.

Like with mode 4 in LTE V2X, when using mode 2 in NR V2X UEs can autonomously select their SL resources from a resource pool, i.e., one or several sub-channels. In this case, UEs can operate without network coverage. The resource pool can be (pre-)configured by the gNB when the UE is in network coverage. NR mode 2 and LTE mode 4 differ on the scheduling scheme. LTE mode 4 operates following a sensing-based SPS scheme, while NR mode 2 can operate using a dynamic or an SPS scheme that differs from the one designed for LTE mode 4. The dynamic scheme selects new resources for each TB and can only reserve resources for the retransmissions of that TB. It is noted that in this section it is distinguished between a selected resource and a reserved resource. A reserved resource is a selected resource that a UE reserves for a future transmission by notifying neighbouring UEs using the 1st-stage SCI messages. A UE can select and reserve resources for the transmission of several TBs and their retransmissions when utilizing the SPS scheme. It is important to note that the SPS scheme can be enabled or disabled in a resource pool by corresponding (pre-)configuration.

Large numbers of radio apparatus, or user equipment (UE), communicating either in accordance with the 4G LTE standard or the 5G NR standard may be within a common radio range and require SL communication. As LTE and NR may use identical portions of the available resources, i.e., may operate on the same frequencies or on at least partially overlapping frequency bands wireless apparatus operating in accordance with either one of the standards may try to transmit at the same time within these mutually used frequencies or frequency bands. The resulting colliding access to the same resource can only be avoided by coordinating access to the commonly used resources.

When both LTE and NR UEs are under coverage of their respective networks, reservation and access coordination to the radio resource may be achieved at the network level, i.e., the eNB and the gNB coordinate the resources that are assigned to the respective UEs. LTE and NR radio access (RA) mechanisms, however, are incompatible, even when the messages required for the RA are transmitted on the same frequency. Thus, if either LTE UEs or NR UEs are not covered by their respective network, network-coordinated access for the two incompatible communication types is not available, as the UEs not covered by their network cannot decode the resource reservation of the respective other network and will resort to the respective self-coordination modes.

It is expected that most if not all of the spectrum intended for ITS use will be allocated to LTE SL, leaving limited or no dedicated ITS spectrum to NR. One motivation to prioritize LTE SL in the ITS spectrum is related to the need to enable the basic safety V2X use cases, such as the ones described in 3GPP TS 22.885, in a relatively short term in as many vehicles as possible, for minimizing the occurrence of traffic related accidents and fatalities. As new vehicles that support both LTE SL and NR SL, and farther in the future NR SL only, continue to be introduced into the market, at some point in time there will be enough market penetration to enable the use of advanced V2X use cases, such as the ones described in 3GPP TS 22.886. However, for these advanced V2X use cases to be feasible it is required that enough spectrum is made available for NR SL both in the ITS band and in other non-ITS bands. While the latter case is being tackled by the introduction in NR SL of features such as carrier aggregation, operation in unlicensed band and beam management at FR2, the former is to be enabled via LTE SL and NR SL co-channel co-existence. Co-channel co-existence allows two different, mutually incompatible radio access technologies (RATs), in this case LTE-SL and NR-SL, to make use of the same radio resources.

Overlapping resource pools between two co-existing RATs can be avoided using a predefined, rigid resource allocation scheme. FIG. 3 a) schematically shows an example of a rigid resource allocation scheme. In the rigid resource allocation scheme resource pools are exclusively allocated within the resource to communication in accordance with one of the two communication standards. The light dotted background represents the commonly used resource, i.e., the channel over time, and the reservations for the different communication standards are indicated by the different hashing. Note that there may or may not be unused spaces between the different resource pool reservations, and that the respective reserved resource pools may have varying lengths and widths, i.e., numbers of contiguous sub-channels. Since the resource allocation is rigid, i.e., fixed, it can be known beforehand in all UEs that operate in accordance with a respective standard. However, while easy to implement, the rigid resource allocation cannot consider different compositions of the respective UEs within the same radio range, i.e., cannot consider cases in which more UEs that communicate in accordance with a first standard are present that those that communicate in accordance with a second standard, and cannot easily be adjusted once implemented in the UEs. Thus, resources in pools reserved for communication in accordance with one standard may go unused, while the resources for communication in accordance with the other standard are insufficient. Generally, this results in inefficiencies whenever the share of UEs of the respective communication standard within the same radio range does not correspond to the respective share in the rigid allocation.

Using unused resource elements reserved for communication in accordance with one communication standard for communication in accordance with the respective other communication standard would increase the use of the overall radio resource and thus the efficiency. However, doing so requires a mechanism to avoid or at least reduce collisions between transmissions in accordance with the two communication standards during such overlapping periods. FIG. 3 b) exemplarily shows overlapping resource pools, where some of the resources intended for communicating in accordance with one standard are used for communication in accordance with the other standard. Here, the resources used for communication in accordance with the overlapping standard are exclusively reserved for this use. This ‘pool occupation’ will still require some coordination, and may still show inefficiencies, e.g., when the ‘occupied’ part of the pool is not fully used for communication in accordance with the occupying standard, but could have been used for communication in accordance with the other standard.

### SUMMARY OF THE INVENTION

It is, therefore, an aim of the present invention to provide methods of coordinating and/or providing, within a given area, access to shared resources by UEs communicating in accordance with otherwise incompatible communication standards, in situations in which network coverage of at least one of the mutually incompatible types is not provided, and in which at least one dual mode UE may be present in the given area, which at least one dual mode UE comprises respective network interfaces for communicating in accordance with each one of the mutually incompatible communication standards.

The various methods presented herein and/or their respective implementation in wireless apparatus and/or network infrastructure elements (NB) may operate individually or complementary to achieve the overall aspects of the invention.

As mentioned before, not all resource elements, sub-channels and time slots are necessarily used within one resource pool provided for communication in accordance with one communication standard, and the unused resource elements are wasted. FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH). Adjacent and nonadjacent refers to the way the transport blocks (TB) are arranged across the subchannels. Using unused resource elements for communication in accordance with the respective other communication standard would increase the use of the overall resource and thus the efficiency.

An aspect of the present invention presented hereinafter addresses at least some of the problems discussed above by introducing at least partially overlapping resource pools in which the overlapping part is used shared by UEs communicating in accordance with respective non-interoperable communication standards, and by introducing methods of coordinating access at least to the shared resource pools.

FIG. 5 shows a schematic example for overlapping resource pools in a frequency channel used for co-channel co-existence, where an overlapping part or portion is used shared. This is possible without causing any problem when not all of the resource elements in the shared part or portion of the resource pools are already fully assigned for communication in accordance with one of the standards, which may have priority access. This situation, i.e., the shared part not being fully assigned for use, may occur more often than not, and the methods proposed herein exploit the resulting opportunity for increasing the use of the radio resource.

LTE has been around for a longer time than NR and is widely deployed, and its use in sidelink operation is fully evolved, stipulated and fixed, i.e., will not be modified any more. Thus, optimization of the coordination can only be achieved through corresponding implementation in the NR system.

An aspect of the present invention thus assumes that LTE UE will be capable of resource reservation within a certain range of the resource pool, indicated as Class A in FIG. 5, and will not know about any possible or actual pool sharing in the overlapping part, labelled Class C. The distinction between Class A and Class C may be known to the LTE network, though. Non-legacy NR UE will know the distinction between Class B and Class C, with Class B being a range within the resource pool that may or be not be exclusive or reserved for 5G NR V2X communication. The not shared portion of Class A may be considered exclusive or reserved for 4G LTE V2X communication.

As mentioned further above, a dynamic resource allocation can be implemented rather easily when UEs for either type of communication standard are within coverage of their respective network, and the coordination is achieved through the network. The situation is different when only one type of network is available, or when no network coverage is present at all.

Prior to a detailed presentation of an aspect of the invention a brief overview over various scenarios addressed by the invention will be given.

As mentioned earlier, the coordination of the resource allocation can either be network-controlled, i.e., the network-through the eNB or gNB-determines and assigns the resources that can be used by a UE in a centralized manner, and the UE simply uses the assigned resources, or UE-controlled. In UE-controlled resource allocation the UEs autonomously and in a distributed manner determine the resources that can be used. Bearing this in mind, RA coordination trouble may arise in scenarios in which UEs exclusively capable of communicating in accordance with the a first standard (UE-A), e.g., the 4G LTE standard, and UEs capable of communicating in accordance with a second standard (UE-B), e.g., the 5G NR standard, are located in areas that have a first standard-only or second standard-only network coverage, e.g., LTE-only or NR-only. In this case, a network-controlled resource allocation will not be known to all UEs within the area of first or second standard-only network coverage, as the resource allocation by the first standard NB is not received or understood by a second standard-only UE-B, and the resource allocation by a second standard NB is not received or understood by a first standard-only UE-A. Hence, the respective UEs that cannot benefit from the network-controlled resource allocation will resort to UE-controlled resource allocation. Since the two resource allocation schemes are not mutually coordinated, allocated resource pools may at least partially overlap, which may result in disturbed or even failed communication attempts due to signal interference.

Coordination trouble may likewise arise in areas without any network coverage at all, when first standard-only UE-A and second standard-only UE-B each try to perform the respective UE-controlled resource allocation. Here, too, the respective UEs that communicate in accordance with respective non-interoperable standards will have no knowledge of the respective other resource allocation, which may result in at least partially overlapping allocated resource pools.

As briefly indicated earlier, some wireless apparatus may be equipped with respective communication interfaces for communicating in accordance with the first standard and the second standard, e.g., 4G LTE and 5G NR. These apparatus may also be referred to as dual mode UEs and are designated herein as UE-C. The corresponding communication interfaces of such wireless apparatus may be communicatively coupled internally in the UE-C, i.e., and the knowledge of resource reservations received in accordance with a respective standard may be shared. However, as yet this shared knowledge remains internal and privy to the respective UE-C, if it is internally shared at all. Thus, even when one or more dual mode UEs are present in the two scenarios discussed above, a full coordination of the resource allocation between first standard-only UE-A and second standard-only UE-B is missing.

FIG. 6 shows exemplary representations of the scenarios discussed above. In FIG. 6 a) only NR network coverage is provided in an area, in which first standard-only UE-A, second standard-only UE-B and dual mode UE-C are located. In the figure the UE-A are represented by the vehicle with the circle with the vertical hashing, the UE-B are represented by the vehicle with the circle with the horizontal hashing, and the UE-C are represented by the vehicle with the circle with the cross-hashing. The NR network, represented by the radio tower icon labelled gNB, can only allocate resources to the UE-A and the NR wireless interface of the UE-C, indicated by the arrows. The UE-B will not have knowledge of the resource allocation through the NR gNB, indicated by the question marks, and will resort to UE-controlled resource allocation performed by the UE-B, which may result in at least partially overlapping resource pools and/or assigned resources.

In FIG. 6 b) only LTE network coverage is provided in an area, in which first standard-only UE-A, second standard-only UE-B and dual mode UE-C are located. Like in FIG. 5 a) the UE-A are represented by the vehicle with the circle with the vertical hashing, the UE-B are represented by the vehicle with the circle with the horizontal hashing, and the UE-C are represented by the vehicle with the circle with the cross-hashing. The LTE network, represented by the radio tower icon labelled eNB, can only allocate resources to the UE-B and the LTE wireless interface of the UE-C, indicated by the arrows. The UE-A will not have knowledge of the resource allocation through the LTE eNB, again indicated by the question marks, and will resort to UE-controlled resource allocation performed by the UE-A, which may result in at least partially overlapping resource pools and/or assigned resources.

FIG. 7 a) schematically shows a scenario in which no network coverage is provided at all in a given area, in which first standard-only UE-A, second standard-only UE-B and dual mode UE-C are located. Like in FIG. 6 a) and b) the UE-A are represented by the vehicle with the circle with the vertical hashing, the UE-B are represented by the vehicle with the circle with the horizontal hashing, and the UE-C are represented by the vehicle with the circle with the cross-hashing. Since no network is available for coordinating radio access, both the UE-A and the UE-B independently perform UE-controlled resource allocation. It is obvious that the UE-A have no knowledge of the allocation agreed to by the UE-B and vice versa, indicated by the questions marks, and that only UE-C that happen to be in the given area can have knowledge of both allocations, indicated by the exclamation marks. In any case, that leaves one or more UEs without a full knowledge of the actual use of the shared resource, which can lead to communication problems.

FIG. 7 b) schematically shows another scenario in which no network coverage is provided at all in a given area, in which first standard-only UE-A and second standard-only UE-B are located, but no dual mode UE-C. Like in FIG. 6 a) and b) and in FIG. 7 a) the UE-A are represented by the vehicle with the circle with the vertical hashing and the UE-B are represented by the vehicle with the circle with the horizontal hashing. Since no network is available for coordinating radio access, both the UE-A and the UE-B independently perform UE-controlled resource allocation. In this scenario it is assumed that either UE-A or UE-B is capable of receiving and understanding at least the resource reservation in accordance with the respective other communication standard. In the figure UE-B has such capability. It is obvious that the UE-A have no knowledge of the allocation agreed to by the UE-B, indicated by the question marks, while the UE-B do have knowledge of the allocation agreed to by the UE-A, indicated by the exclamation marks. In any case, this leaves one or more UEs without a full knowledge of the actual use of the shared resource, which can lead to communication problems.

In accordance with an aspect of the present invention the situation presented in FIG. 6 a) is addressed as follows, with the UE-B communicating in accordance with the 5G NR standard and the UE-A communicating in accordance with the 4G LTE standard in the following example:
1. The UE-B and the NR part of the UE-C send their respective reservation requests to the NR gNB together with the reservation for the respective LTE part of the UE-C, using the NR Uu uplink interface.
2. The NR gNB assigns resources to the UE-B and to the respective NR parts of the UE-C, respecting the LTE reservations.
   For the UE-C the NR gNB sends a downlink broadcast indicating the resources within the Class C, which are available in a future window.
   The UE-B receive their resource allocation in the normal way.
3. The gNB'S broadcast signal is received and decoded by the NR part of the UE-C.
4. The NR part of the UE-C then transfers the decoded message, i.e., the available resources in Class C, to the LTE part of the UE-C using an intra-UE coordination message.
5. The LTE part of the UE-C then sends a “coordinated” resource reservation information to the UE-A and the LTE part of other UE-C within radio range, in a way as stipulated in the LTE standard, thus identifying available or not reserved resources in Class A.
6. The UE-A will be aware of the reservation performed in step 5 as this will be broadcast by the LTE part of the UE-C, and the UE-A will select or reserve resources accordingly, as stipulated in LTE mode 4.

An exemplary message flow for the main steps of the reservation in the situation of FIG. 6 a) is shown in FIG. 8.

The situation presented in FIG. 6 b) is addressed as follows, again with the UE-B communicating in accordance with the 5G NR standard and the UE-A communicating in accordance with the 4G LTE standard in the following example:
1. The UE-A and the LTE part of UE-C send their reservation requests to the LTE eNB, using the LTE Uu uplink interface.
2. The LTE eNB assigns resources to the UE-A and to the LTE part of the UE-C.
   For the UE-C the LTE eNB sends a downlink broadcast indicating the resources within the Class C, which are available in a future window.
   The UE-A receive their resource allocation in the normal way.
3. The LTE eNB's broadcast signal is received and decoded by the LTE part of the UE-C.
4. The LTE part of the UE-C then transfers the decoded message, i.e., the available resources in Class C, to the NR part of the UE-C using an intra-UE coordination message.
5. The NR part of the UE-C then sends the relevant resource allocation information, i.e., available or not-assigned resources in Class C to the UE-B within radio range, e.g., using a sidelink broadcast message or via SCI phase 1.
6. Based on this knowledge, UE-B in accordance with NR release 18 perform a conventional resource reservation in accordance with the 5G NR standard, i.e., using Class B with highest priority and Class C with lowest priority.
7. Legacy UE-B, i.e., in accordance with NR release 16 or 17 will be aware of the reservation performed in step 6 as this will be broadcast by the NR part of the UE-C, and they will select or reserve resources accordingly.

An exemplary message flow for the main steps of the reservation in the situation of FIG. 6 b) is shown in FIG. 9.

Note that in case some UE-B are capable of listening to and understanding the LTE resource reservation messages, steps 4 and 5 may not be required for these UE-B.

The situation presented in FIG. 7 a) is addressed as follows, yet again with the UE-B communicating in accordance with the 5G NR standard and the UE-A communicating in accordance with the 4G LTE standard in the following example:
1. UE-A and the LTE part of UE-C make and/or announce their reservation in Class A, without assuming any prioritization.
2. The NR part of UE-C gets this information, e.g., via internal data transfer from the LTE part or, if capable thereof, by directly listening to LTE resource reservation messages, and broadcasts the intended reservation of the UE-A and the LTE part of the UE-C, using a broadcast message which is received by all UE-B and UE-C.
3. UE-B and UE-C take into consideration this information and try to get resources in the coordinated part, i.e., in Class C.
4. Legacy UE-B, i.e., those not capable of sharing resources in Class C, select and/or reserve resources in Class B.

An exemplary message flow for the main steps of the reservation in the situation of FIG. 6 a) is shown in FIG. 10.

The situation presented in FIG. 7 b) is addressed as follows, yet again with the UE-B communicating in accordance with the 5G NR standard and the UE-A communicating in accordance with the 4G LTE standard in the following example:
1. UE-A make and/or announce their reservation in Class A, without assuming any prioritization.
2. UE-B gets this information and broadcasts the intended reservation of the UE-A, using a broadcast message which is received by all UE-B.
3. UE-B take into consideration this information and try to get resources in the coordinated part, i.e., in Class C.
4. Legacy UE-B, i.e., those not capable of sharing resources in Class C, select and/or reserve resources in Class B.

It is noted that in this example it is assumed that the UE-B can listen to and understand resource reservation messages from UE-A.

An exemplary message flow for the main steps of the reservation in the situation of FIG. 7 b) is shown in FIG. 11.

Generally, it is noted that non-legacy UE-B are preferably configured to prioritize resources in Class C over resources in Class B for communication with non-legacy UE-B, while communication with or between legacy UE-B preferably uses resources in Class B. Legacy UE-B may include, e.g., 5G NR UEs earlier than those complying with 5G NR release 18, i.e., complying with 5G NR releases 16 or 17.

Thus, in accordance with a first aspect of the invention a method of coordinating access of at least one first-type apparatus comprising a first-type wireless interface, at least one second-type apparatus comprising a second-type wireless interface, and at least one third type apparatus comprising both a first-type wireless interface and a second-type wireless interface that are communicatively coupled to each other, to radio resources is presented, parts or portions of which radio resources being at least partly and/or temporarily used shared between the first-type, second-type and third-type apparatus. The first-type and second-type wireless communication interfaces are not interoperable. The expression partly shared may be interpreted as relating to the simultaneous, respectively exclusive use of channels, sub-channels, time slots or resource elements of the radio resources for communications via wireless interfaces of the first and second type. The resource elements may comprise physical resource blocks, channels, sub-channels, or groups thereof, and may further comprise time slots, or any combination of any of the aforementioned elements. The method comprises, in the third-type apparatus, receiving a resource allocation response assigning resource elements in the at least partly and/or temporarily shared parts or portions of the future radio resources and/or in parts or portions of the future radio resources that are exclusive to or reserved for use by first-type apparatus or by first-type interfaces of third-type apparatus, or receiving an announcement pertaining to reserved resource elements in said shared or exclusive parts or portions of the future radio resources, and/or obtaining first information indicating at least resource elements within the at least partly and/or temporarily shared parts or portions of the future radio resources that are available or not assigned. From the resource allocation response, the announcement and/or the obtained first information indicating at least available or not assigned resource elements a second information is generated that permits identifying at least the available or not-assigned resource elements within the at least partly and/or temporarily shared parts or portions of the future radio resources. The second information is then transmitted, via the second-type wireless interface of the third-type apparatus, to any second-type wireless interface within radio range. Transmitting the second information may be effected, e.g., via an SL broadcast message or an SCI Phase 1 message in case the second-type wireless interface operates in accordance with the 5G NR standard, or via an LTE resource reservation information in case the second-type wireless interface operates in accordance with the 4G LTE standard. The second information may comprise a bitmap of the shared resource elements, showing the resource elements or groups thereof that are available or not assigned, or the inverse thereof, i.e., the unavailable or assigned ones.

Receiving a resource allocation response may comprise receiving such response from a base station of a network configured for communication with first-type wireless interfaces.

Obtaining first information may comprise obtaining such information from the base station, e.g., in a downlink broadcast, or by other means or protocol provided in a respective standard that stipulates communication over and/or control of first-type wireless interfaces.

Receiving an announcement may comprise receiving such announcement from one or more first-type apparatus or from first-type interfaces of third-type apparatus.

The second-type wireless interface may be configured to directly receive such resource allocation response, and to extract relevant information in electronic circuitry associated with the second-type wireless interface. Otherwise, the resource allocation response is received by the first-type wireless interface and is internally, i.e., within the third-type apparatus, transferred to electronic circuitry for generating the second information, which is then transmitted. If received in coded form, the received information may be decoded in electronic circuitry associated with the first-type wireless interface prior to being internally transferred.

Throughout this specification electronic circuitry associated with the first-type wireless interface may have common elements with the electronic circuitry associated with the second-type wireless interface, e.g., when the actual function of the electronic circuitry associated with the first-type or second-type wireless interface is implemented as computer program instructions, these may be executed by the same physical microprocessor or physical or logical core thereof, using the same physical volatile memory.

In one or more embodiments of the method electronic circuitry of the third-type apparatus performs, prior to receiving a resource allocation response, resource reservation, through the base station of a network configured for communication with first-type wireless interfaces, targeting any resource element within a part or portion of the future radio resources provided for communication via first-type wireless interfaces. In other words, such resource reservation may include resource elements within the at least partly and/or temporarily shared parts or portions of the future radio resources, and may further include resource elements in parts or portions of the future radio resources that are exclusive to or reserved for use by first-type apparatus or by first-type wireless interfaces of third-type apparatus.

Alternatively, electronic circuitry associated with the first-type wireless interface performs, prior to receiving a resource allocation response and to obtaining first information, resource reservation, through the base station of a network configured for communication with first-type wireless interfaces, targeting any resource element within a part or portion of the future radio resources provided for communication via first-type wireless interfaces and within the at least partly and/or temporarily shared parts or portions of the future radio resources, and further including, in the resource reservation, a resource pre-reservation targeting resource elements in parts or portions of the future radio resources that are reserved for use by second-type apparatus or by second-type wireless interfaces of third-type apparatus and/or targeting resource elements within the at least partly and/or temporarily shared parts or portions of the future radio resource.

In another alternative, electronic circuitry associated with the first-type wireless interface, prior to receiving an announcement, makes or announces a reservation within a part or portion of the future radio resources provided for communication via first-type wireless interfaces.

The electronic circuitry associated with the first-type wireless interface or with the second-type wireless interface, or both, may comprise, inter alia, one or more microprocessors, associated volatile and non-volatile memory, and may execute computer program instructions, stored in the non-volatile memory, that execute decoding, coding, inter-apparatus sharing of information, and/or control of physical elements of wireless interfaces or other elements of the apparatus it is provided in.

In accordance with a second aspect of the invention a method of allocating radio resource elements to first-type apparatus comprising a first-type wireless interface, second-type apparatus comprising a second-type wireless interface, and at least one third type apparatus comprising both a first-type wireless interface and a second-type wireless interface that are communicatively coupled to each other, to parts or portions of future radio resources, of which parts or portions are at least partly and/or temporarily used shared by the first-type, second-type and third-type apparatus. The first-type and second-type wireless communication interfaces are not interoperable. The expression partly shared may be interpreted as relating to the simultaneous, respectively exclusive use of channels, sub-channels or resource elements of the radio resource within the time interval for communications via wireless interfaces of the first and second type. The resource elements may comprise physical resource blocks, channels, sub-channels, or groups thereof, and may further comprise time slots, or a combination thereof. The method comprises, in an apparatus of a network infrastructure configured for communication with first-type wireless interfaces, e.g., a base station or a network controller, receiving, from one or more first-type apparatus and/or one or more third type apparatus, reservation requests targeting at least resource elements in shared parts or portions of the future radio resources. In response to the requests from first-type apparatus or from first-type interfaces of third-type apparatus resource elements are assigned. The assigned resource elements are transmitted to the one or more first-type apparatus or first-type wireless interfaces of the third-type apparatus through resource allocation responses in accordance with the appropriate communication standard. In accordance with an aspect of the invention, information indicating resource elements within the at least partly and/or temporarily shared parts or portions of the future radio resources that are available or not assigned for use by first-type apparatus or by first-type interfaces of third-type apparatus is sent to the one or more first-type apparatus or first-type wireless interfaces of the third-type apparatus, e.g., through a downlink broadcast message.

In one or more embodiments of the method in accordance with the second aspect of the invention receiving further comprises receiving, from one or more first-type apparatus and/or first-type wireless interfaces of one or more third type apparatus, reservation requests targeting resource elements in parts or portions of the future radio resources that are exclusive to or reserved for use by first-type apparatus or by first-type interfaces of third-type apparatus.

In one or more embodiments of the method in accordance with the second aspect of the invention receiving further comprises receiving, from one or more first-type wireless interfaces of one or more third type apparatus, pre-reservations for a second-type wireless interface of said third-type apparatus targeting resource elements in parts or portions of the future radio resources that are generally accessible for use by second-type apparatus or by second-type interfaces of third-type apparatus. Pre-reservations may indicate resource elements that the second-type wireless interface has reserved during a preceding autonomous resource reservation process, unbeknownst to the first-type interface, or that it intends to reserve during a subsequent autonomous resource reservation process. Generally accessible may be interpreted as comprising any resource element from the radio resource that can normally be reserved in accordance with communication via the second communication interface, including source elements that are part of parts or portions radio resource time intervals which are used shared for communication via first-type wireless interfaces. This embodiment of the method further comprises identifying, in the pre-reservations, those resource elements arranged in shared parts or portions of the future radio resources. The pre-reservations targeted to resource elements arranged in shared parts or portions of the future radio resources that were previously identified are respected or considered in the assigning step.

The methods according to aspects of the invention presented herein improve the co-existence of mutually incompatible wireless communication systems in the presence of dual-mode UEs, by making resource reservations for apparatus or wireless interfaces operating in accordance with the first communication standard and/or information about available or not-assigned resource elements available to apparatus or wireless interfaces operating in accordance with the respective other communication standard via the dual-mode UEs. In case no network coverage is present at all, LTE group reservation is prioritized, which is either available to UEs in compliance with NR Release 18 and later, which are assumed to be able to receive and decode LTE resource reservation, or through intra-UE information sharing in dual-mode UEs. The methods presented herein are backward-compatible with existing resource reservation and allocation schemes and provide semi-persistent and dynamic resource sharing between two otherwise not-interoperable communication standards.

The various aspects, and developments and embodiments thereof, presented hereinbefore may individually or interconnectedly address one or more of the problems initially discussed.

The method described hereinbefore may be represented by computer program instructions. Accordingly, a computer program product comprises computer program instructions which, when executed by a microprocessor of a wireless apparatus, communication device or network component cause the microprocessor to execute methods in accordance with one or more of the methods of aspects of the present invention presented herein, and to accordingly control hardware and/or software blocks or modules of the wireless apparatus, communication device or network component in accordance with aspects of the invention as likewise presented herein.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

An aspect of the present invention can be used with great advantage in all communication scenarios in which communication in accordance with mutually non-interoperable standards occurs in the same or at least overlapping resources, e.g., frequency channels. A particularly useful application of an aspect of the invention is the side link communication in vehicle-to-X (V2X) communication scenarios in the ITS frequency spectrum.

### BRIEF DESCRIPTION OF THE DRAWING

Aspects of the invention will now be described with reference to the drawing, in which

FIG. 1 schematically illustrates the channelization in LTE V2X mode 4 sensing-based SPS scheduling with an exemplary length T =100 ms,

FIG. 2 schematically illustrates the concept of resource pools,

FIG. 3 shows examples of overlapping resource pools in a channel used by two otherwise not-interoperable radio access technologies,

FIG. 4 depicts an exemplary LTE resource pool structure showing, inter alia, reserved or allocated resource elements and available resource elements for an adjacent resource assignment and a nonadjacent resource assignment in the physical SL control channel (PSCCH) and the physical SL shared channel (PSSCH),

FIG. 5 shows a schematic example for overlapping resource pools in a frequency channel used for co-channel co-existence, where an overlapping part or portion is used shared,

FIG. 6 shows exemplary representations of situations addressed by an aspect of the present invention in the presence of at least one radio access network,

FIG. 7 shows exemplary representations of situations addressed by an aspect of the present invention when no radio access network is present,

FIG. 8 shows an exemplary message flow of a first implementation of the methods in accordance with an aspect of the present invention,

FIG. 9 shows an exemplary message flow of a second implementation of the methods in accordance with an aspect of the present invention,

FIG. 10 shows an exemplary message flow of a third implementation of the methods in accordance with an aspect of the present invention,

FIG. 11 shows an exemplary message flow of a fourth implementation of the methods in accordance with an aspect of the present invention,

FIG. 12 shows an exemplary schematic block diagram of a wireless apparatus or communication device in accordance with an aspect of the present invention,

FIG. 13 shows an exemplary schematic block diagram of a network component in accordance with an aspect of the present invention, and

FIG. 14 shows the main steps of the methods in accordance with the first and the second aspect of the invention in relation to each other, further showing message exchanges between them.

In the figures identical or similar elements may be referenced using the same reference designators.

### DETAILED DESCRIPTION OF EXEMPLARY EMBODIMENTS

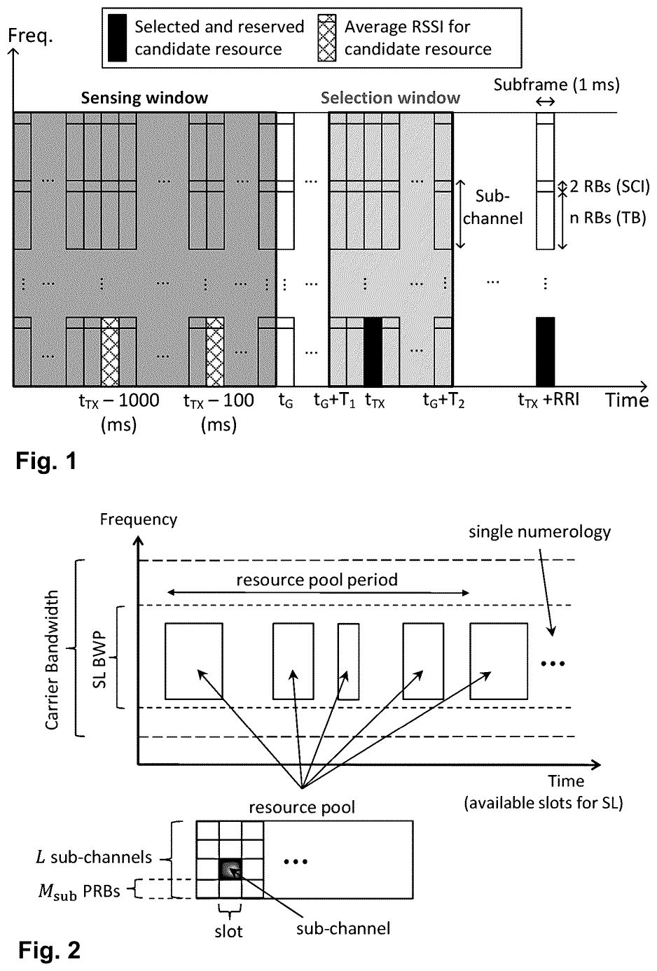

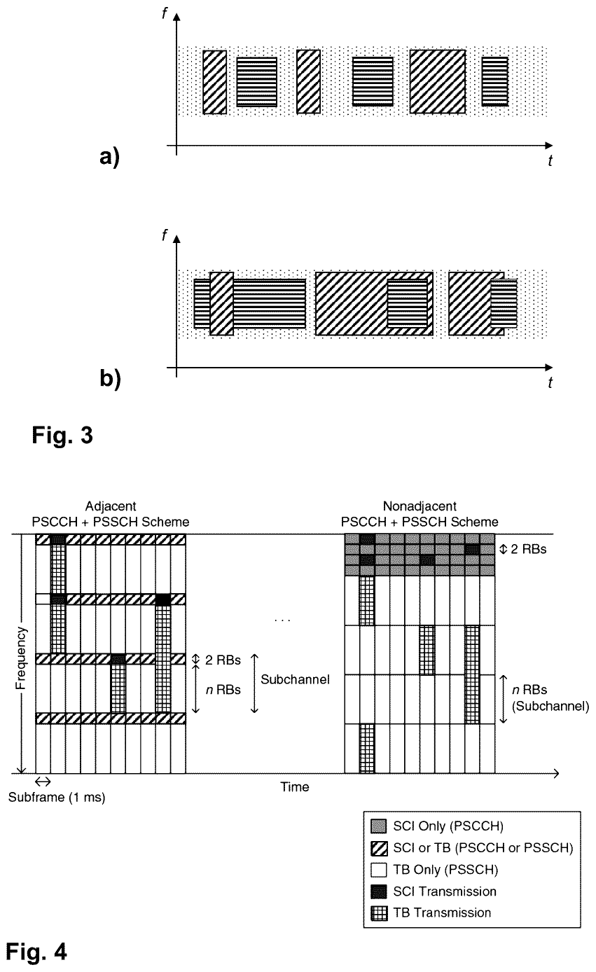

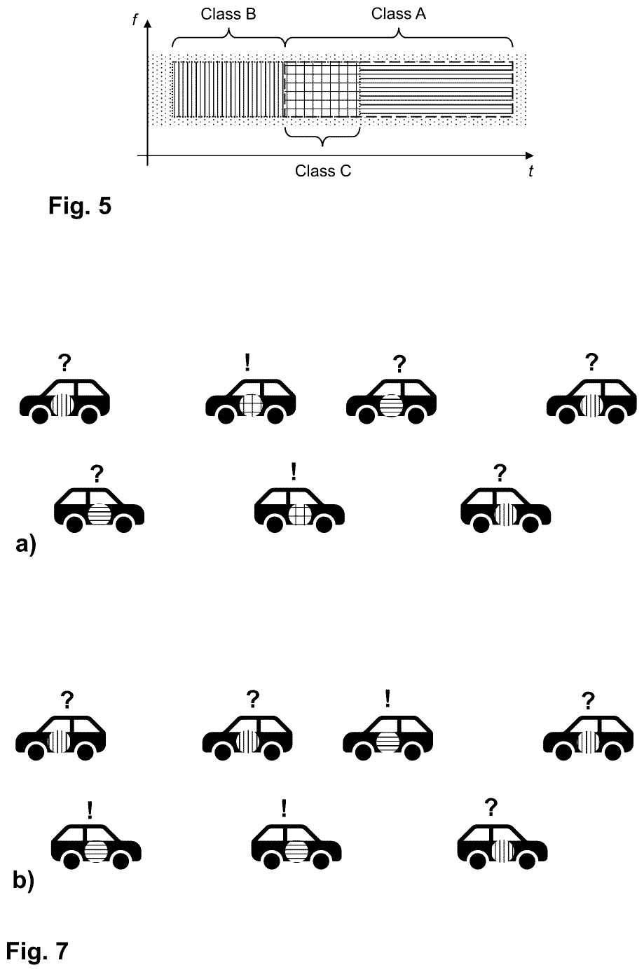

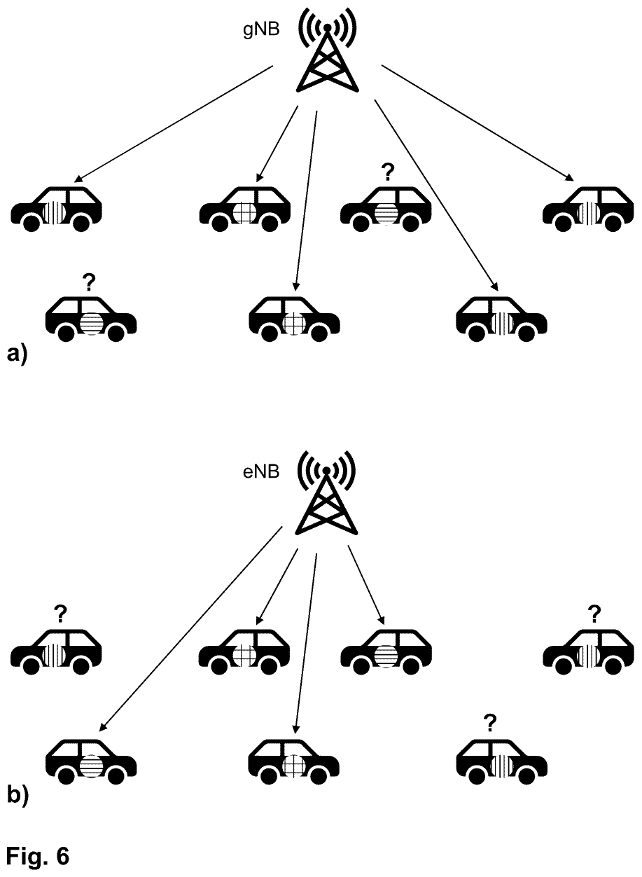

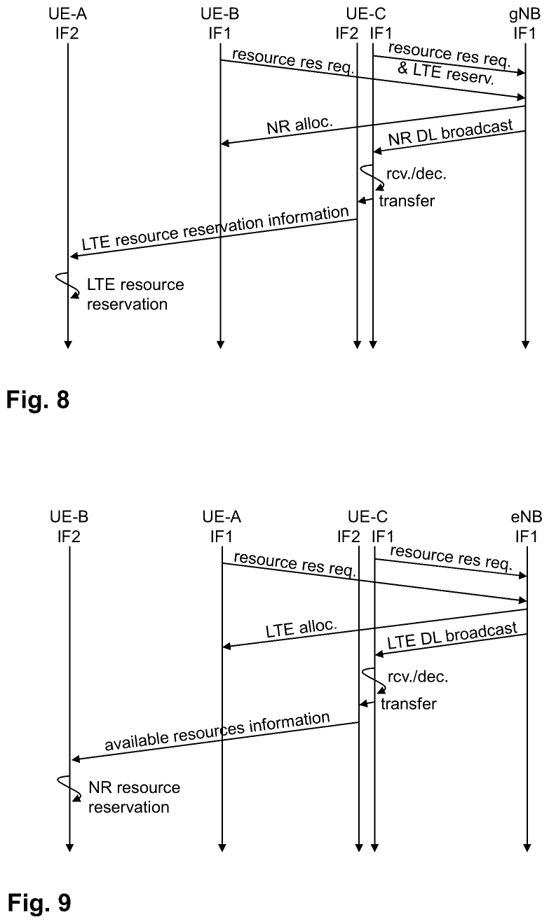

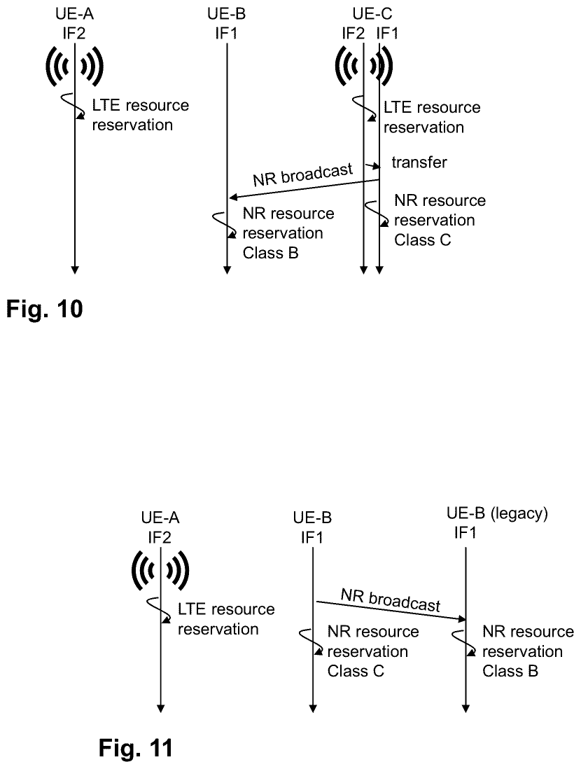

FIGS. 1 to 11 have already been discussed further above and will not be addressed again.

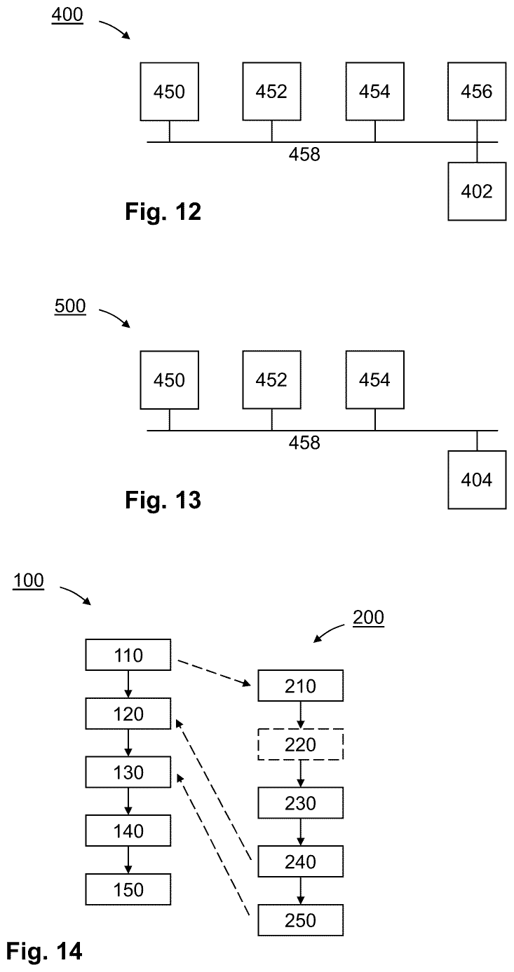

FIG. 12 shows an exemplary schematic block diagram of a wireless apparatus or communication device 400 in accordance with a third aspect of the present invention. The wireless apparatus or communication device 400 comprises one or more antennas 402 and associated wireless interface circuitry 456, providing at least one first-type communication interface and one second-type communication interface, for communicating with one or more further wireless apparatus or communication devices or a network component 500 (not shown in the figure), one or more microprocessors 450, volatile memory 452 and non-volatile memory 454. The aforementioned elements are communicatively connected via one or more signal or data connections or buses 458. The non-volatile memory 454 stores computer program instructions which, when executed by the microprocessor 450, cause the wireless apparatus or communication device 400 to execute the method according to first aspect of the invention as presented hereinbefore.

FIG. 13 shows an exemplary schematic block diagram of a network component 500 in accordance with an aspect of the present invention. The network component 500 comprises one or more microprocessors 450, volatile memory 452, non-volatile memory 454, and a first-type or second-type wireless interface 404 for communicating with one or more wireless apparatus or communication devices 400 in accordance with the third aspect of the present invention (not shown in the figure). The aforementioned elements are communicatively connected via one or more signal or data connections or buses 458. The non-volatile memory 454 stores computer program instructions which, when executed by the microprocessor 450, cause the network component 500 to execute the method according to the second aspect of the invention as presented hereinbefore.

FIG. 14 shows the main steps of the methods 100 and 200 in accordance with the first and the second aspect of the invention, respectively, in relation to each other, further showing message exchanges between them. In step 110 the UE performs a resource reservation of future resources for use by a first-type wireless interface IF1 and transmits a corresponding request to the NB. The NB optionally identifies, in step 220, resource elements arranged in shared parts or portions of the future radio resources, from pre-reservations for a second-type wireless interface IF2 received along with the resource reservation request. In step 230 the NB assigns resource elements in accordance with the requests and optionally considering the pre-reservations. In step 240 responses to the resource allocation for the first-type wireless interface IF1 are transmitted, which are received, in step 120, by the UE. In step 250 the NB sends first information indicating resource elements within the at least partly and/or temporarily shared parts or portions of the future radio resources that are available or not assigned for use by first-type wireless interface IF1, which are received by the UE in step 130. In step 140 the UE generates, based on the first information, second information permitting identifying at least the available or not-assigned resource elements within the at least partly and/or temporarily shared parts or portions of the future radio resources, which is transmitted in step 150.

### LIST OF REFERENCE NUMERALS (PART OF THE DESCRIPTION)

100 method
110 perform resource reservation/announce
120 receive allocation response
130 obtain first information
140 generate second information
150 transmit second information
200 method
210 receive reservation requests
220 identify resource elements in shared parts or portions
230 assign resources
240 transmit allocation response
250 send resource element information
400 apparatus/communication device
402 antenna
404 1^{st}-/2^{nd}-type interface
450 microprocessor
452 volatile memory
454 non-volatile memory
456 wireless interface circuitry
458 signal/data connection/bus
500 network component
IF1 first-type IF
IF2 second-type IF
UE-A first-type UE
UE-B second-type
UE-C third-type UE

1. A method of coordinating access of at least one first-type apparatus comprising a first-type wireless interface, at least one second-type apparatus comprising a second-type wireless interface, and at least one third type apparatus comprising both a first-type wireless interface and a second-type wireless interface that are communicatively coupled to each other, to radio resources, parts or portions of which radio resources are at least partly and/or temporarily shared between the first-type, second-type and third-type apparatus, wherein the first-type and second-type wireless communication interfaces are not interoperable, and wherein the method comprises, in the third-type apparatus:
receiving a resource allocation response assigning resource elements in the at least partly and/or temporarily shared parts or portions of the future radio resources and/or in parts or portions of the future radio resources that are exclusive to or reserved for use by first-type apparatus or by first-type interfaces of third-type apparatus or receiving an announcement pertaining to reserved resource elements in said shared or exclusive parts or portions of the future radio resources, and/or obtaining first information indicating at least resource elements within the at least partly and/or temporarily shared parts or portions of the future radio resources that are available or not assigned,
generating, from the resource allocation response, the announcement and/or the obtained first information indicating at least available or not assigned resource elements, second information permitting identifying at least the available or not-assigned resource elements within the at least partly and/or temporarily shared parts or portions of the future radio resources, and
transmitting, via the second-type wireless interface, the second to any second-type wireless interface within radio range.

2. The method of claim 1, wherein receiving a resource allocation response comprises receiving such response from a base station of a network configured for communication with first-type wireless interfaces.

3. The method of claim 2, wherein obtaining first information comprises obtaining such information from the base station.

4. The method of claim 1, wherein receiving an announcement pertaining to reserved resource elements in said shared or exclusive parts or portions of the future radio resources comprises receiving such announcement from one or more first-type apparatus or from first-type interfaces of third-type apparatus.

5. The method of claim 1 wherein, if the second-type wireless interface is not configured to directly receive resource allocation responses, first information and/or an announcement transmitted a base station of a network configured for communication with first-type wireless interfaces or from a first-type wireless interface, the method comprises receiving corresponding messages through the first-type wireless interface of the third-type apparatus, prior to transferring corresponding information to electronic circuitry for generating the second information.

6. The method of claim 1, further comprising, in the third-type apparatus and prior to the receiving step:
electronic circuitry associated with the first-type wireless interface performing resource reservation, through a base station of a network configured for communication with first-type wireless interfaces, targeting any resource element within a part or portion of the future radio resources provided for communication via first-type wireless interfaces, or
electronic circuitry associated with the first-type wireless interface performing resource reservation, through a base station of a network configured for communication with first-type wireless interfaces, targeting any resource element within a part or portion of the future radio resources provided for communication via first-type wireless interfaces and within the at least partly and/or temporarily shared parts or portions of a future radio resources, and further including, in the resource reservation, a resource pre-reservation targeting resource elements in parts or portions of the future radio resources that are exclusive to or reserved for use by second-type apparatus or by second-type wireless interfaces of third-type apparatus and/or targeting resource elements within the at least partly and/or temporarily shared parts or portions of the future radio resources, or
electronic circuitry associated with the first-type wireless interface making or announcing a reservation within a part or portion of the future radio resources provided for communication via first-type wireless interfaces.

7. A method of allocating radio resource elements to a first-type apparatus comprising a first-type wireless interface, a second-type apparatus comprising a second-type wireless interface, and at least one third type apparatus comprising both a first-type wireless interface and a second-type wireless interface that are communicatively coupled to each other, to parts or portions of future radio resources, of which parts or portions are at least partly and/or temporarily used shared by the first-type, second-type and third-type apparatus, wherein the first-type and second-type wireless communication interfaces are not interoperable, and wherein the method comprises, in an apparatus of a network infrastructure configured for communication with first-type wireless interfaces:
receiving, from one or more first-type apparatus and/or first-type wireless interfaces of one or more third type apparatus, reservation requests targeting at least resource elements in shared parts or portions of the future radio resources,
assigning resource elements to the requests from first-type apparatus or from first-type interfaces of third-type apparatus,
transmit one or more resource allocation responses to the one or more first-type apparatus or first-type wireless interfaces of the third-type apparatus, and
sending information indicating resource elements within the at least partly and/or temporarily shared parts or portions of the future radio resources that are available or not assigned for use by first-type apparatus or by first-type interfaces of third-type apparatus.

8. The method of claim 7, wherein receiving further comprises:
receiving, from one or more first-type apparatus and/or first-type wireless interfaces of one or more third type apparatus, reservation requests targeting resource elements in parts or portions of the future radio resources that are exclusive to or reserved for use by first-type apparatus or by first-type interfaces of third-type apparatus.

9. The method of claim 7, wherein receiving further comprises:
receiving, along with the reservation requests from the first-type wireless interfaces of one or more third type apparatus, pre-reservations for a second-type wireless interface of said third-type apparatus targeting resource elements in parts or portions of the future radio resources that are generally accessible for use by second-type apparatus or by second-type interfaces of third-type apparatus, and
identifying, in the pre-reservations, those resource elements arranged in shared parts or portions of the future radio resources prior to assigning resource elements in response to the requests, wherein the pre-reservations targeted to resource elements arranged in shared parts or portions of the future radio resources that were previously identified are respected or considered in the assigning step.

10. A wireless apparatus or communication device comprising at least one transmitting and/or receiving antenna and associated electronic radio frequency circuitry providing at least one first-type communication interface and one second-type communication interface, further comprising a microprocessor and associated volatile and non-volatile memory, wherein the aforementioned elements are communicatively connected via one or more signal or data connections or buses, wherein the non-volatile memory stores computer program instructions which, when executed by the microprocessor configure the wireless communication apparatus for performing a method of claim 1.

11. A network component comprising one or more volatile-microprocessors, volatile memory, non-volatile memory, and a first-type or second-type wireless interface for communicating with one or more wireless apparatus or communication devices in accordance with claim 1, wherein the aforementioned elements are communicatively connected via one or more signal or data connections or buses, wherein the non-volatile memory stores computer program instructions which, when executed by the microprocessor configure the network component for performing a method of allocating radio resource elements to a first-type apparatus comprising a first-type wireless interface, a second-type apparatus comprising a second-type wireless interface, and at least one third type apparatus comprising both a first-type wireless interface and a second-type wireless interface that are communicatively coupled to each other, to parts or portions of future radio resources, of which parts or portions are at least partly and/or temporarily used shared by the first-type, second-type and third-type apparatus, wherein the first-type and second-type wireless communication interfaces are not interoperable, and wherein the method comprises, in an apparatus of a network infrastructure configured for communication with first-type wireless interfaces:
receiving, from one or more first-type apparatus and/or first-type wireless interfaces of one or more third type apparatus, reservation requests targeting at least resource elements in shared parts or portions of the future radio resources, assigning resource elements to the requests from first-type apparatus or from first-type interfaces of third-type apparatus,
transmitting one or more resource allocation responses to the one or more first-type apparatus or first-type wireless interfaces of the third-type apparatus, and
sending information indicating resource elements within the at least partly and/or temporarily shared parts or portions of the future radio resources that are available or not assigned for use by first-type apparatus or by first-type interfaces of third-type apparatus.

12. A computer program product comprising instructions which, when the instructions are executed by a microprocessor, cause a computer and/or control hardware blocks, modules or components of an apparatus or communication device comprising at least one transmitting and/or receiving antenna and associated electronic radio frequency circuitry, providing at least one first-type communication interface and one second-type communication interface, further comprising a microprocessor and associated volatile and non-volatile memory, wherein the aforementioned elements are communicatively connected via one or more signal or data connections or buses, wherein the non-volatile memory stores computer program instructions which, when executed by the microprocessor configure the wireless communication apparatus to carry out a method according to claim 1.

13. A non-transitory computer readable medium or data carrier retrievably transmitting or storing the computer program product of claim 12.

14. A computer program product comprising instructions which, when the instructions are executed by a microprocessor, cause a computer and/or control hardware blocks, modules or components of an apparatus or communication device comprising at least one transmitting and/or receiving antenna and associated electronic radio frequency circuitry, providing at least one first-type communication interface and one second-type communication interface, further comprising a microprocessor and associated volatile and non-volatile memory, wherein the aforementioned elements are communicatively connected via one or more signal or data connections or buses, wherein the non-volatile memory stores computer program instructions which, when executed by the microprocessor configure the wireless communication apparatus to carry out a method according to claim 7.

15. A computer program product comprising instructions which, when the instructions are executed by a microprocessor, cause a computer and/or control hardware blocks, modules or components of a network component comprising one or more microprocessors, volatile memory, non-volatile memory, and a first-type or second-type wireless interface for communicating with one or more wireless apparatus or communication devices, wherein the aforementioned elements are communicatively connected via one or more signal or data connections or buses, wherein the non-volatile memory stores computer program instructions which, when executed by the microprocessor configure the network component to carry out a method of claim 1.

16. A computer program product comprising instructions which, when the instructions are executed by a microprocessor, cause a computer and/or control hardware blocks, modules or components of a network component comprising one or more microprocessors, volatile memory, non-volatile memory, and a first-type or second-type wireless interface for communicating with one or more wireless apparatus or communication devices, wherein the aforementioned elements are communicatively connected via one or more signal or data connections or buses, wherein the non-volatile memory stores computer program instructions which, when executed by the microprocessor configure the network component to carry out a method of claim 7.
